(19) United States
(12) Patent Application Publication
(10) Pub. No.: US 2026/0187008 A1
(43) Pub. Date: Jul. 2, 2026

(54) HOT-PLUG PROTECTION SYSTEMS AND DEVICES WITH STATUS INDICATORS

(71) Applicant: Aivres Systems Inc., San Jose, CA (US)

(72) Inventor: Yi-sheng Hsieh, New Taipei City (TW)

(21) Appl. No.: 19/003,047

(22) Filed: Dec. 27, 2024

(51) Int. Cl. G06F 13/40

(52) U.S. Cl. CPC G06F 13/4077; G06F 2213/40

(57) ABSTRACT

Systems, devices, and methods for hot plug protection are provided. In one aspect, a system includes a host device configured to receive a load. The host device includes a protection circuit that is configured to: measure a value of a property associated with the load, determine whether the measured value of the property exceeds a protection threshold, and take a protection action in response to determining that the measured value of the property exceeds the protection threshold. The host device includes a controller and a light emitting device. The protection circuit is further configured to in response to the measured value of the property exceeding the protection threshold, send a first signal to the controller. The controller is configured to control the light emitting device to emit a corresponding light beam of the plurality of light beams with a corresponding characteristic of the plurality of characteristics.

### BACKGROUND

Hot Plug (Hot Plug/Hot Swap) is a technology designed to increase operational flexibility and ease of maintenance for electronic devices. Hot plug technology can be used in data centers, industrial automation equipment and consumer electronics.

### SUMMARY

The present disclosure describes systems and techniques for hot plug protection systems and devices with status indicators.

In an implementation, a system includes a host device configured to receive a load. The host device includes a protection circuit configured to be coupled to the load. The protection circuit is configured to: measure a value of a property associated with the load, determine whether the measured value of the property exceeds a protection threshold, and take a protection action in response to determining that the measured value of the property exceeds the protection threshold. The host device includes a controller coupled to the protection circuit and a light emitting device coupled to the controller and configured to emit a plurality of light beams with a plurality of characteristics. The protection circuit is further configured to: in response to the measured value of the property exceeding the protection threshold, send a first signal indicative of the measured value of the property exceeding the protection threshold to the controller. The controller is configured to: receive the first signal and control the light emitting device based on at least the first signal to emit a corresponding light beam of the plurality of light beams with a corresponding characteristic of the plurality of characteristics.

The subject matter described in this specification can be implemented to realize one or more of the following benefits and/or advantages. For example, first, a hot plug protection circuit (e.g., a hot plug controller integrated circuit (IC)) can enable real-time monitoring of operational signal of the load, including changes in current and voltage during the plug-in or unplugging process. A controller (e.g., a microcontroller unit (MCU)) can receive the measurement data from the hot plug protection circuit. The controller can analyze the measurement data and determine the load status (e.g., normal, abnormal, or standby). Based on determined status, the controller can control a light emitting device (e.g., a light emitting diode (LED)) to generate a corresponding light signal. Different load status can be indicated by LEDs with different characteristics, e.g., different colors and/or flashing frequency (e.g., flashing or solid). In contrast to a single status indicator (e.g., by a single-color light), the multi-color indicators implemented by the light emitting device can visually reflect operational risks or abnormal conditions, further enhancing user awareness of system status and enabling users to take protective measures if needed. Additionally, the technologies can be user-friendly by providing users clear and intuitive status feedback, which may reduce the risk of incorrect operation.

Second, the protection circuit can be configured to protect the load against over-current, over-voltage and/or short circuit. When an abnormality (e.g., over-current, over-voltage and/or short circuit) is detected, the protection circuit can effectively isolate the load by either limiting the current or cutting off the power provided to the load to ensure device security and avoid device damage. In addition, the protection circuit can be configured to store the measurement data in response to a detection of an abnormality, providing fault logging for quick troubleshooting by users or maintenance personnel.

Therefore, the technologies described in the present disclosure enable two-fold security: when an abnormality is detected (e.g., poor contact with the load, overload, the protection circuit being powered off, or the protection circuit in a current limiting mode), (i) the protection circuit is configured to perform a protection action to avoid further damage to the equipment or load, and (ii) a controller is configured to control a light emitting device to emit a light beam indicative of the abnormality. This two-fold security enables both immediate protective measures to safeguard the load and the system and clear visual indication for rapid troubleshooting and maintenance, thereby enhancing operational reliability and reducing downtime.

Further, in some implementations, the controller is configured to work with the protection circuit to implement a hierarchical protection mechanism. For example, when a minor abnormality is detected, the protection circuit can be configured to limit the current applied to the load, while when a severe abnormality is detected, the protection circuit can be configured to completely cut off the power applied to the load.

Finally, the technologies can enhance system adaptability. The technologies allow a host to support complex multi-module load scenarios and dynamically adjust protection thresholds based on real-time measurement of load conditions. This can ensure security and reliability for multi-scenario applications.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of an example hot plug protection system.

FIG. 2 is a block diagram of an example hot plug protection device installed in a host.

FIG. 3 illustrates example events detectable by a controller.

FIG. 4 is a flow chart of an example process of a method for operating a hot plug protection system.

FIG. 5 is a block diagram illustrating an example computer-implemented system.

Like reference numbers and designations in the various drawings indicate like elements.

### DETAILED DESCRIPTION

In a data center, hot-plug technology can be used for server modules and storage devices, allowing module replacement and maintenance without disrupting system operations. In recent years, with the widespread popularity of electronic products and the increased demand for performance improvement, hot-plug applications not only increase operational flexibility, but also improve assembly and maintenance efficiency. However, hot-plug applications also introduce the risk of equipment damage caused by transient current or voltage fluctuations during the plug-in and/or unplugging process. More advanced protection mechanisms and operational guidance are urgently needed, especially for highly sensitive equipment.

The following detailed description describes systems and techniques for a hot plug protection system and device with status indicators. The hot plug protection system and device can include at least a protection circuit, a controller and a light emitting device, and can be presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

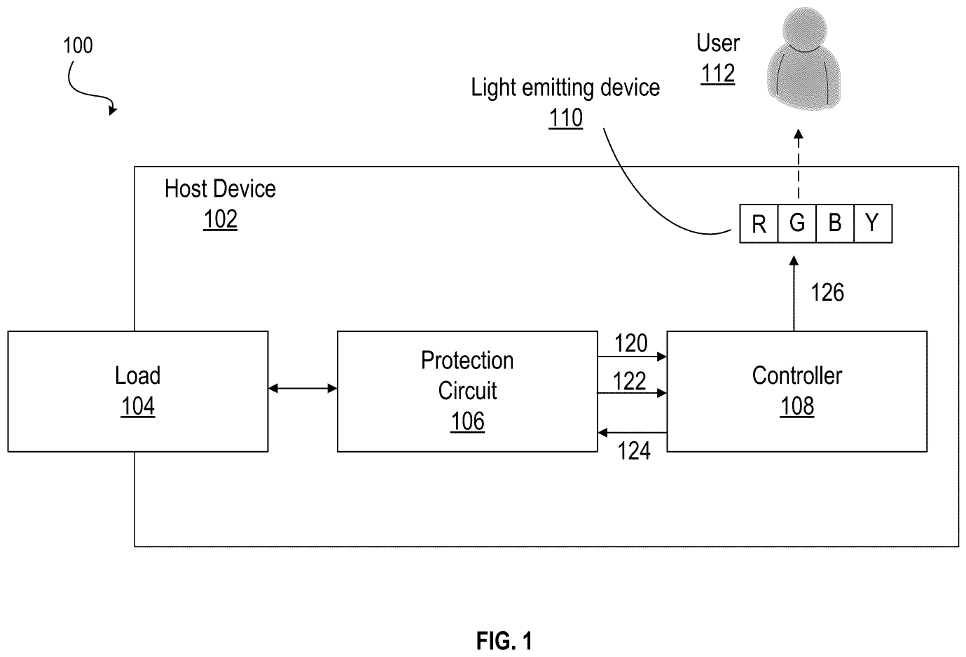

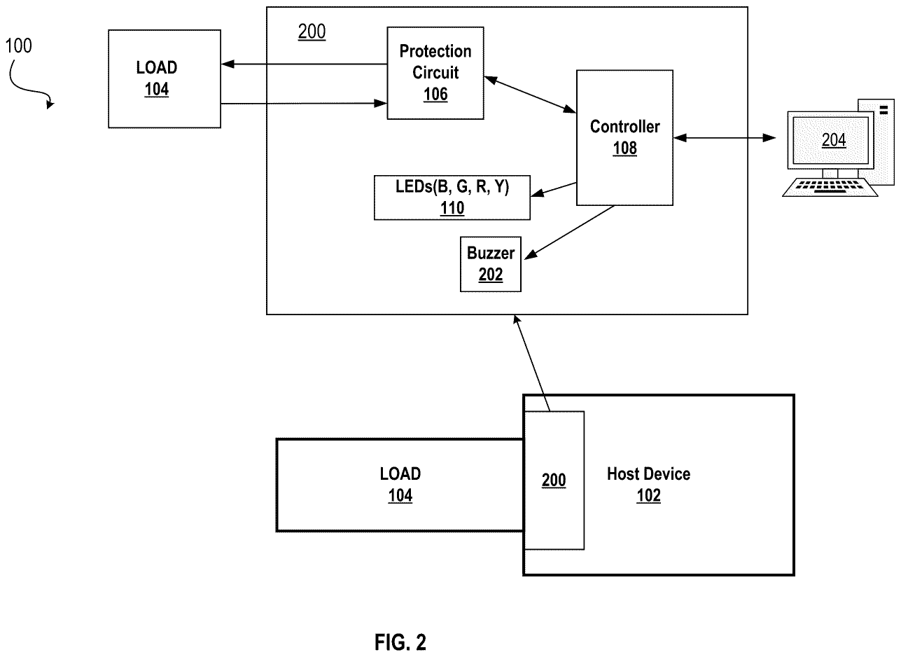

FIG. 1 is a block diagram of an example hot plug protection system 100. FIG. 2 is a block diagram of an example hot plug protection device 200 installed in a host device 102. For ease of description, reference will be made to both FIGS. 1 and 2 when describing the structure of the hot plug protection system and device.

As illustrated in FIG. 1, the hot plug protection system 100 includes a host device 102 (also called a host in some cases) configured to receive a load 104. The host device 102 can be a device or a system that provides services or communications to other devices on the network. For example, the host device 102 can be a computing system (such as a server) or a computing device (such as a computer). The host device 102 can supply built-in devices (e.g., circuits, controller) to which the load 104 is inserted or connected and be responsible for powering all built-in devices and the load 104. For example, the host device 102 can include a motherboard and the built-in devices and the load can be integrated on the motherboard.

In some implementations, the host device 102 includes a hot plug protection device 200 (e.g., as illustrated in FIG. 2). The hot plug protection device 200 can be included in an input/output (I/O) interface of the host device 102. The hot plug protection device 200 can include a protection circuit 106, a controller 108 and a light emitting device 110. In some examples, the load 104 can be plugged into the host device 102 or unplugged from the host device 102 without needing to power down the host device 102 or restart it. The examples of load 104 include, without limitation to, a fan, a universal serial bus (USB), a storage device, or a graphics card. In some implementations, the hot plug protection system 100 further includes the load 104 that is attachable to and removable from the host device 102.

In some implementations, the protection circuit 106 is configured to protect against electrical surges or faults when the load 104 is being plugged in, remains connected and/or is being unplugged. In some implementations, the protection circuit 106 includes a hot swap controller integrated circuit (IC). The hot swap controller IC can include, without limitation to, Texas Instruments TI LM5066.

In some implementations, the controller 108 is a microcontroller unit (MCU) and configured to control and/or communicate with the protection circuit 106. For example, the controller 108 can be configured to communicate with the protection circuit 106 through inter-integrated circuit (I²C) or serial peripheral interface (SPI) communication bus in both directions. In some implementations, the controller 108 is also configured to communicate with the protection circuit 106 using an analog signal as described in detail below.

In some implementations, the light emitting device 110 includes one or more light emitting diodes (LEDs). The one or more LEDs can be configured to emit a plurality of light beams with a plurality of light characteristics (e.g., multiple colors) in response to signals from the controller 108. The light emitting device 110 can provide dynamic, real-time user guidance that visually indicate load status, system status and/or protection circuit status, reducing the risk of mis-operation. Four example LED colors are illustrated in FIGS. 1 and 2, including red, green, blue and yellow. It is to be understood that the example in FIGS. 1 and 2 is for illustration purpose and is not intended to be construed in a limiting sense. The LEDs can emit light beams with any other color, e.g., purple, orange.

As discussed with further details below, in some implementations, the protection circuit 106 is configured to measure current and voltage data associated with the load 104 in real time. Based on real-time detection data, at least one of the protection circuit 106 or the controller 108 can be configured to determine a load status (e.g. normal, abnormal, poor contact) and categorize abnormal events for subsequent diagnosis. Based on the determined load status, the controller 108 can be configured to drive the light emitting device 110 to emit a corresponding light beam indicating the current load status. The light beams can be used as intuitive indicators for users by employing different lighting colors (e.g., green, yellow, red, blue) and modes (e.g., flashing or solid light) to signify different events. Additionally, the controller 108 can be configured to work with the protection circuit 106 to implement a hierarchical protection mechanism. For example, different protection actions can be performed based on severity of detected abnormality.

### Protection Circuit

When the load 104 is plugged into the host device 102, the protection circuit 106 can be configured to be electrically coupled to the load 104 (e.g., through VIN or VCC pins, VOUT pin, and/or SENSE pins). The protection circuit 106 can be configured to: (i) measure a value of a property associated with the load 104, (ii) determine whether the measured value of the property exceeds a protection threshold, and/or (iii) take a protection action in response to determining that the measured value of the property exceeds the protection threshold. In some implementations, the property associated with the load 104 includes at least one of an electrical current, an electrical voltage, an electrical impedance, or a temperature. For example, the protection circuit 106 can be configured to monitor current and voltage of the load 104 in real-time. In the event of an abnormal load (e.g. overcurrent, short circuit, or overvoltage), the protection circuit 106 can take a protection action to avoid further damage to the host device 102 or load 104. In some implementations, the protection action includes limiting an electrical current provided to the load 104 or cutting off a power provided to the load 104.

In some implementations, the protection circuit 106 is configured to determine a state of the load 104 based on the measured value of the property. The state of the load 104 includes at least one of minor abnormality or severe abnormality. In some implementations, the protection circuit 106 is configured to determine the state of the load 104 by determining a deviation of the measured value of the property from the protection threshold. For example, the minor abnormality can refer to small, temporary deviations from normal operating parameters, e.g., slight overcurrent (e.g., exceeding a current protection threshold by up to 20%), slight voltage overshoot (e.g., exceeding a voltage protection threshold by up to 20%), or slight thermal runaway (e.g., exceeding a temperature threshold by up to 20° C.). The severe abnormality can refer to large deviations that pose an immediate threat to the system's safety and reliability, e.g., hard overcurrent (e.g., exceeding the current protection threshold by more than 20%), severe overvoltage (e.g., exceeding the voltage protection threshold by more than 20%), or severe thermal runaway (e.g., exceeding the temperature threshold by more than 20° C.).

In some implementations, the protection circuit 106 is configured to: (i) in response to a determination of the minor abnormality, limit the electrical current provided to the load 104; and (ii) in response to a determination of the severe abnormality, cut off the power provided to the load 104. In some implementations, limiting the electrical current provided to the load 104 includes reducing the electrical current by a preset percentage, e.g., at least 50%. In some implementations, limiting the electrical current provided to the load 104 includes reducing the electric current to a level that brings the load current within the current protection limit. In some implementations, cutting off the power provided to the load 104 includes turning off a Metal-Oxide-Semiconductor Field-Effect Transistor (MOSFET) that is used as a switch for connecting/disconnecting the load 104 from the power supply.

In some implementations, in response to the measured value of the property exceeding the protection threshold, the protection circuit 106 is configured to send a first signal 120 (e.g., as illustrated in FIG. 1) indicative of the measured value of the property exceeding the protection threshold to the controller 108. The first signal 120 can be a digital signal. The first signal 120 can be sent from the protection circuit 106 to the controller 108, e.g., via a General-Purpose Input/Output (GPIO) pin or a dedicated FAULT pin. In some examples, the FAULT pin of the protection circuit 106 can output a low-level digital signal to the controller 108 when an abnormality (e.g., overcurrent) is detected. The low-level digital signal can be accepted by a GPIO pin of the controller 108.

In some implementations, the protection circuit 106 is further configured to transmit a second signal 122 (e.g., as illustrated in FIG. 1) indicative of the measured value of the property to the controller 108. For example, the protection circuit 106 can transmit the load current and voltage data monitored in real time to the controller 108. As discussed in further details below, the controller 108 can be configured to analyze the measured data to determine an event (e.g., the load 104 has been plugged, the load 104 has been plugged but not have been activated, or poor connection between the load 104 and the protection circuit 106).

In some implementations, the protection circuit 106 is configured to measure a current of the load 104 via a sampling resistor and output the second signal 122 in the form of a voltage signal or a current signal.

In some implementations, the second signal 122 is an analog signal, and the protection circuit 106 is configured to output the analog signal, e.g., from a current detection pin to an analog-to-digital converter (ADC)-capable pin of the controller 108. In some examples, the controller 108 can include an ADC and process the second signal 122 using the ADC. The ADC-capable pin of the controller 108 can be a pin that is configured to handle and convert analog signals into digital format for processing. The current detection pin of the protection circuit 106 can be a pin that is configured to communicate with the ADC-capable pin of the controller 108 for analog signal transmission. In some examples, ADC sampling frequencies can be from 1 kHz to 10 kHz, depending on at least the response time requirements of the system and the ADC sampling capability of the controller 108.

In some other implementations, the second signal 122 is a digital signal and transmitted to the controller 108 through I²C or SPI communication protocol. The protection circuit 106 can include an ADC that coverts the measured analog signal (e.g., current, voltage, temperature) to a digital signal. The converted digital signal can be then transmitted to the controller 108 through I²C or SPI communication bus. In some examples, the I²C bus can operate at a frequency ranging between 100 kHz and 400 kHz. In some other examples, some high-performance I²C bus can support 1 MHz. The SPI bus communication can support 10 MHz to 50 MHz for high data volumes and fast real-time communication scenarios.

In some implementations, in response to determining that the measured value of the property exceeds the protection threshold, the protection circuit 106 is further configured to store the measured value of the property. Alternatively, or in addition, the controller 108 can be configured to store the measured value (e.g., based on the second signal 122) and/or to cause a memory to store the measured value. Storing the measurement data in response to a detection of an abnormality can provide fault logging for quick troubleshooting by users or maintenance personnel.

In some implementations, the protection circuit 106 is configured to measure the value of the property associated with the load 104 at a frequency between 1000 Hz to 10,000 Hz. In some implementations, the protection circuit 106 is configured to provide power to the load 104.

The detection range for the property associated with the load 104 can be set according to the operating voltage and current of the load 104. In some examples, the protection circuit 106 (e.g., a hot swap controller IC) can support dynamic monitoring from micro-ampere levels to large current ranges (e.g. 0 A to 20 A) and/or from low to high voltage ranges (e.g. 5 V to 60 V).

### Controller

In some implementations, the controller 108 is configured to receive the first signal 120 and control the light emitting device 110 based on at least the first signal 120 to emit a corresponding light beam of the plurality of light beams with a corresponding characteristic of the plurality of characteristics. For example, as noted above, the first signal 120 can be a low-level digital signal. In response to receiving the first signal 120, the controller 108 can control the light emitting device 110 to emit a light beam (e.g., a red light beam). The red light beam can be visible to users or maintenance personnel and used to signal them that an abnormality of the load 104 (e.g., overcurrent, overvoltage, or short circuit) has been detected.

Alternatively, or in addition, the controller 108 can be configured to determine the state of the load 104 based on the second signal 122 received from the protection circuit 106. The state of the load 104 can include at least one of minor abnormality or severe abnormality, as described above. In some implementations, the controller 108 is configured to determine the state of the load 104 by determining a deviation of the measured value of the property from the protection threshold. In some implementations, the controller 108 is configured to: (i) in response to a determination of the minor abnormality, control the protection circuit 106 to limit an electrical current provided to the load 104, and (ii) in response to a determination of the severe abnormality, control the protection circuit 106 to cut off a power provided to the load 104. For example, the protection circuit 106 can measure the property of the load 104 and transmit the measured data to the controller 108 in real time (e.g., at a frequency in a range between 1000 Hz and 10000 Hz). After receiving the measured data, the controller 108 can be configured to determine the state of the load 104 based on how much the measured value deviates from the corresponding protection thresholds. In response to determining a minor abnormality or a severe abnormality, the controller 108 can send a corresponding control signal 124 (e.g., via I²C or SPI communication protocol) to the protection circuit 106 to take a corresponding protection action. Therefore, the controller 108 can work in conjunction with the protection circuit 106 to provide a hierarchical protection: (i) for minor abnormality, performing a current limit protection to ensure load safe operation; and (ii) for severe abnormality, performing an open circuit protection to prevent further damage to the host device 102 and/or the load 104.

As noted above, the protection circuit 106 can transmit to the controller 108 a first signal 120 (e.g., a digital signal (FAULT)) for fault conditions and a second signal 122 (e.g., an analog signal) for measured current and voltage values. The first signal 120 can be event driven, for example, the first signal 120 can be transmitted only in the event of a fault or an abnormality, while the second signal 122 can be transmitted in real time.

The frequency at which the protection circuit 106 communicates with the controller 108 can depend on the real-time requirements and the communication methods. In some implementations, the controller 108 is configured to detect the first signal at a corresponding input pin every 0.5 ms to 2 ms (e.g., 1 ms). In some implementations, the protection circuit 106 is configured to transmit the second signal 122 at a frequency in a range between 1000 Hz and 10000 Hz. In some implementations, the protection circuit 106 is configured to read the second signal 122 every 5 ms to 15 ms (e.g., 10 ms) at a corresponding input pin. In some implementations, the controller 108 is configured to read the second signal 122 (e.g., an analog signal) at a sampling frequency of 1 KHz to 10 KHz (e.g., 5 kHz) to calculate current and voltage changes.

In some implementations, the controller 108 is configured to adjust the protection threshold based on the second signal 122. The second signal 122 can provide real-time measurement values of the current and/or voltages, establishing a baseline for load performance. The protection thresholds can be set based on this baseline behavior. For example, if the protection thresholds are set too low initially (e.g., within six sigma of the normal current or voltage range when the load 104 is operating normally), overcurrent and/or overvoltage alarms may be triggered frequently. In such cases, by analyzing the baseline behavior of the load 104 using the second signal 122, the controller 108 can adjust the protection thresholds to go beyond six sigma, reducing false alarms and ensuring that only meaningful abnormalities are detected.

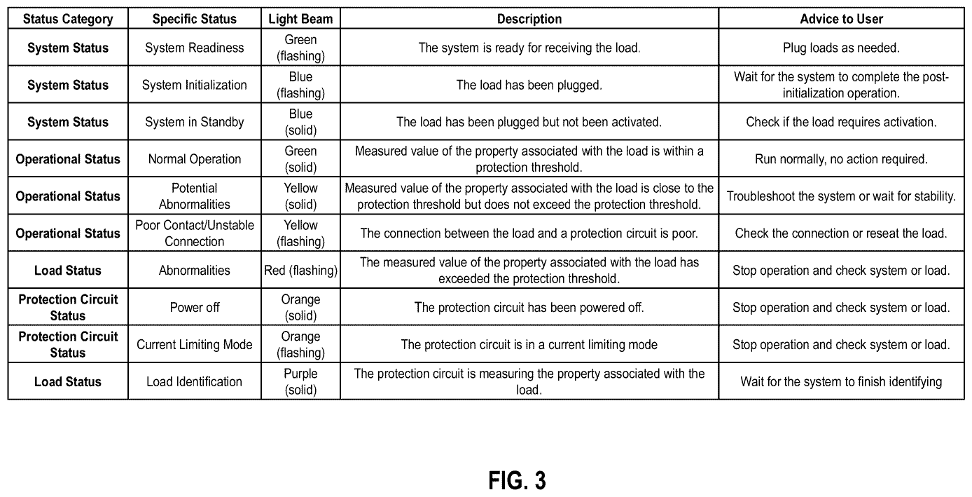

In some implementations, the controller 108 is configured to, based on at least one of the first signal 120 or the second signal 122, (i) determine at least one of one or more events; and (ii) for each of the one or more events, control the light emitting device 110 to emit a corresponding light beam of the plurality of light beams with a corresponding characteristic of the plurality of characteristics. The controller 108 can control the light emitting device 110 through a control signal 126, as illustrated in FIG. 1. FIG. 3 illustrates example events that can be detected by the controller 108. It is understood that the examples in FIG. 3 are for illustration purpose and are not intended to be construed in a limiting sense. The controller 108 can be configured to detect any other suitable events.

In some implementations, as illustrated in FIG. 3, the one or more events that can be detected by the controller 108 include at least one of:
an event where the host device 102 is ready to receive the load 104;
an event where the load 104 has been plugged;
an event where the load 104 has been plugged but not been activated;
an event where the measured value of the property associated with the load 104 is within the protection threshold;
an event where the measured value of the property associated with the load 104 is close to the protection threshold but does not exceed the protection threshold;
an event where a connection between the load 104 and the protection circuit 106 is poor;
an event where the measured value of the property associated with the load 104 has exceeded the protection threshold;
an event where the protection circuit 106 has been powered off;
an event where the protection circuit 106 is in a current limiting mode; or
an event where the protection circuit 106 is measuring the property associated with the load 104.

As noted above, the light emitting device 110 can include one or more LEDs. In some examples, the controller 108 can drive LEDs via one or more GPIOs. In some implementations, the plurality of characteristics of the light beams include at least one of one or more colors, or one or more flashing frequencies. For example, the plurality of light beams with the plurality of characteristics can include at least one of a flashing blue light, a solid blue light, a flashing green light, a solid green light, a flashing yellow light, a solid yellow light, a flashing red light, a solid red light, a flashing orange light, a solid orange light, a flashing purple light, or a solid purple light. It is to be noted that the light beam may not encode any specific data, but rather be used as an intuitive signal for users. Just like a traffic light that can use different colors to communicate with drivers and pedestrians, indicating when to stop, proceed or prepare to stop, different light characteristics can be used to convey specific instructions to users or maintenance personnels. Different user advice (or instructions) for different light beams can be provided in a user manual, rather than encoded in the light beams.

In some implementations, a single light beam characteristic can be used to indicate one or more events. For example, a solid red light can be used to indicate that (i) a minor abnormality has been detected, (ii) specifically, an overvoltage has been detected, and/or (iii) the protection circuit 106 is in a current limiting mode. Alternatively, the controller 108 can be configured to control the light emitting device 110 to emit a light beam with distinct light characteristic for each event. For example, a solid red light can be used to indicate only that a minor abnormality has been detected.

As illustrated in FIG. 3, for each event that is detected by the controller 108, a corresponding light beam with a corresponding characteristic can be emitted, signaling the users to take corresponding actions. Example detection methods for the events, along with example light characteristics and example advice for the users associated with the light beams, are provided below:
(1) System readiness (e.g., an even where system is ready for receiving or rejecting the load 104): a controller 108 can detect a status of the protection circuit 106 (e.g., normal or abnormal) to make sure the protection circuit 106 are functioning normally, e.g., by an I²C or SPI communication bus. If the protection circuit 106 is functioning normally, the controller 108 can control the light emitting device 110 to generate a flashing green light to indicate that the system 100 is ready to receive or reject a load 104. The green light can signal to the users to plug and/or unplug the load 104 as needed.
(2) System initialization (e.g., an event where the load 104 has been plugged): when the system 100 is powered up, the protection circuit 106 can be configured to detect if the load 104 is plugged by checking a load entry (e.g., as determined by impedance or current signal). In some examples, checking the load entry includes detecting electrical signals on one or more pins (e.g., Vcc pin or data line pins). In response to determining that the load 104 has been plugged in, the protection circuit 106 can be configured to send a signal (e.g., a signal different from the first signal 120 and the second signal 122) to the controller 108. In response to receiving the signal, the controller 108 can control the light emitting device 110 to generate a flashing blue light. The flashing blue light may indicate to the users that the load 104 has been plugged in.
(3) System in standby (e.g., an event where the load 104 has been plugged but not been activated): the system 100 can be configured to detect a current flow through the load 104. When the system 100 detects a presence of the load 104 (e.g., by impedance) but does not detect a current flow through the load 104, this may indicate that the load 104 has been plugged but not been activated. In some implementations, the protection circuit 106 is configured to measure the current and impedance of the load 104 and send the measured value to the controller 108 through the second signal 122. In some implementations, the controller 108 is configured to determine that the load 104 has been plugged but not been activated by determining at least one of: a measured value of the electrical current being smaller than a current threshold, or a measured value of the electrical impedance being greater than an impedance threshold. In some implementations, in response to determining that the load 104 has been plugged but not been activated, the controller 108 is configured to control the light emitting device 110 to emit a corresponding light beam, e.g., a solid blue light. The solid blue light can be used to indicate that the system 100 is in standby, and/or advise the users to check if the load 104 requires activation.
(4) Normal operation (e.g., an event where the measured value of the property associated with the load 104 is within the protection threshold): as noted above, the protection circuit 106 can be configured to send the first signal 120 (e.g., a FAULT signal) in the event of a fault or an abnormality. In some examples, the first signal 120 can be event driven. If the measured value of the property is within the threshold (e.g., no abnormality detected), the controller 108 may not receive the first signal 120. Therefore, the controller 108 can be configured to determine whether the measured value is within the protection threshold based on whether the controller 108 has received the first signal 120 from the protection circuit 106.

Alternatively, or in addition, the controller 108 can be configured to determine whether the measured value of the property associated with the load 104 is within the protection threshold by independently comparing the measured value received from the protection circuit 106 (e.g., based on the second signal 122) with corresponding thresholds. In response to determining that the measured value is within the protection threshold, the controller 108 can be configured to control the light emitting device 110 to emit a corresponding light beam, e.g., a solid green light. The green light can indicate that the load 104 runs normally and no action is required from the users.
(5) Potential Abnormalities (e.g., an event where the measured value of the property associated with the load 104 is close to the protection threshold but does not exceed the protection threshold): when the measured value of the property associated with the load 104 is approaching the protection threshold but does not exceed the protection threshold, it may indicate that a potential abnormality could occur soon. The controller 108 can be configured to compare the measured value of properties received from the protection circuit 106 with corresponding protection thresholds to determine whether the measured values are close to the protection thresholds (e.g., within 15%). In some implementations, the controller 108 is configured to determine a specific type of potential abnormality, and the type of potential abnormality includes at least one of a potential overload state or an unstable supply voltage. In some implementations, the controller 108 is configured to determine the type of potential abnormality based on at least one of the measured current or measured voltage. For example, the controller 108 can be configured to detect a potential overload state (e.g., where the possibility that the system 100 could soon experience an overload situation is high) by determining that the measured current is close to the current threshold. In another example, the controller 108 can be configured to determine that a supply voltage has abnormal fluctuation by determining that the measured voltage is close to the voltage threshold.

In some implementations, in response to determining that the measured value of the property associated with the load 104 is close to the protection threshold but does not exceed the protection threshold, the controller 108 is configured to control the light emitting device 110 to emit a corresponding light beam, e.g., a solid yellow light. The solid yellow light can be used to instruct the users to troubleshoot the system or wait for the measured values of the load 104 to stabilize. In some implementations, the controller 108 is configured to control the light emitting device 110 to emit different light beams for different types of potential abnormality. For example, for the potential overload state, a solid yellow light can be emitted, while for the abnormal fluctuation of the supply voltage, a flashing yellow light or a yellow light that gradually transitions to an orange light and then back can be emitted.
(6) Poor contact/unstable connection (e.g., an event where a connection between the load 104 and the protection circuit 106 is poor): when the connection between the load 104 and the protection circuit 106 is poor (e.g., loose plug), impedance and/or current signals may have abnormal fluctuations. Severe poor contact may pose a risk of overcurrent. The protection circuit 106 can be configured to (i) monitor the impedance and/or current values in real time and (ii) determine the frequency and magnitude of fluctuations of these values. In response to abnormally high frequency and/or abnormally large magnitude of the fluctuation (e.g., exceeding corresponding thresholds), the protection circuit 106 can be configured to take a protection action, e.g., limiting a current flow to restrict the overcurrent and protect the system.

In addition, or alternatively, the controller 108 can be configured to determine the poor connection or contact by (i) determining at least one of a magnitude of fluctuation of the measured value of the property, or a frequency of the fluctuation of the measured value of the property and (ii) comparing the frequency and/or magnitude of fluctuations with corresponding thresholds. In some implementations, the controller 108 and/or the protection circuit 106 is configured to record the abnormal frequency or abnormal magnitude of the fluctuations. In response to abnormally high frequency and/or abnormally large magnitude of the fluctuations, the controller 108 can be configured to control the light emitting device 110 to emit a corresponding light beam, e.g., a flashing yellow light. The flashing yellow light can signal to the users to check the load connection or reseat the load 104 in the host device 102.
(7) Abnormality (e.g., an event where the measured value of the property associated with the load 104 has exceeded the protection threshold): as noted above, the abnormality can include at least one of overcurrent, overvoltage, or short circuit of load 104. Based on the severity of the abnormality (e.g., minor abnormality, or severe abnormality), the protection circuit 106 can be configured to take a corresponding protection action (e.g., limiting the current for minor abnormality, or cutting off the power for severe abnormality) and output the first signal 120 to the controller 108.

In some implementations, the protection circuit 106 is configured to determine the severity of the abnormality. Alternatively, or in addition, the controller 108 can be configured to independently determine the severity of the abnormality based on the second signal 122, as described above. In the example implementations where the controller 108 is configured to determine the severity of the abnormality, the controller 108 is configured to (i) control the protection circuit 106 to take a corresponding protection action and (ii) control the light emitting device 110 to emit a corresponding light beam, e.g., a red light.

In some implementations, the controller 108 is configured to control the light emitting device 110 to emit different light beams based on the severity of the abnormality. For example, the controller 108 can control the light emitting device 110 to emit a solid red light in response to a determination of minor abnormality, while it can control the light emitting device 110 to emit a flashing red light in response to a determination of severe abnormality.

In some implementations, the controller 108 is configured to determine a specific type of abnormality, for example, whether it is overcurrent, overvoltage or short circuit. In some implementations, the controller 108 is configured to detect an overcurrent based on a determination that the measured current value of the load 104 exceeds a first current threshold but remains below a second current threshold, with the second current threshold being greater than the first current threshold. In some implementations, the controller 108 is configured to detect a short circuit based on a determination that the measured current value exceeds the second current threshold. In some implementations, the first current threshold and the second current threshold are both set in the protection circuit 106. In some implementations, the first current threshold is set in the protection circuit 106, and the second current threshold is determined by the controller 108. In some implementations, the controller 108 is configured to determine the overvoltage based on a determination that the measured voltage value of the load 104 is exceeding a voltage threshold.

In some implementations, the controller 108 is configured to control the light emitting device 110 to emit different light beams based on different types of abnormality. For example, the controller 108 can control the light emitting device 110 to (i) emit a solid red light in response to a determination of an overvoltage, (ii) emit a flashing red light at a first flashing frequency in response to a determination of an overcurrent, and (iii) emit a flashing red light at a second flashing frequency (e.g., higher than the first flashing frequency) in response to a determination of a short circuit. Different light characteristics can indicate the same or different operation advice, e.g., to stop the operation of the system 100, to troubleshoot the load 104 and system 100, and/or to store an abnormality record.
(8) Status of protection circuit 106-powered off (e.g., an event where the protection circuit 106 has been powered off): the controller 108 can be configured to determine whether the protection circuit 106 has been powered off through I²C or SPI communication protocol. In some examples, the controller 108 can be configured to send a status check signal to the protection circuit 106, and if no signal is returned to the controller 108 from the protection circuit 106, it may indicate that the protection circuit 106 is powered off. In response to detecting that the protection circuit 106 has been powered off, the controller 108 can be configured to control the light emitting device 110 to emit a corresponding light beam, e.g., a solid orange light beam.
(9) Status of protection circuit 106—current limiting mode (e.g., an event where the protection circuit 106 is in a current limiting mode): the controller 108 can be configured to determine whether the protection circuit 106 is in a current limiting mode through I²C or SPI communication protocol. In some examples, the controller 108 can be configured to send a status check signal to the protection circuit 106, and in response, the protection circuit 106 can be configured to return a dedicated status signal (e.g., “CURRENT_LIMITING_MODE”) to the controller 108, indicating that it is in a current limiting mode. In response to detecting that the protection circuit 106 in a current limiting mode, the controller 108 can be configured to control the light emitting device 110 to emit a corresponding light beam, e.g., a flashing orange light beam.
(10) Load identification (e.g., an event where the protection circuit 106 is measuring the property associated with the load 104): when the load 104 is being inserted into the host device 102, the protection circuit 106 can be triggered to start measuring property associated with the load 104. Measuring property associated with the load 104 can include (i) testing an initial state of load impedance, current and/or voltage and (ii) determining whether the measured values are within protection thresholds during the insertion of the load 104. The protection circuit 106 can be configured to monitor current and voltage changes in real time during the plug-in process.

While the load 104 is being plugged in, the controller 108 can monitor the load testing process performed by the protection circuit 106. In some implementations, the controller 108 is configured to determine whether the protection circuit 106 is measuring the property associated with the load 104, e.g., by monitoring specific signals or data exchanges that can confirm active measurement. For example, the controller 108 can be configured to send a status check signal to the protection circuit 106, and in response, the protection circuit 106 can be configured to return a dedicated status signal (e.g., “MEASUREMENT_ACTIVE”) to the controller 108, indicating that it is actively measuring the property.

In response to determining that the protection circuit 106 is measuring the property associated with the load 104, the controller 108 can control the light emitting device 110 to emit a corresponding light, e.g., a solid purple, to advise the user to wait for measurement to complete.

In some implementations, referring back to FIG. 2, the system includes a buzzer 202 coupled to the controller 108 and configured to generate at least one sound. The controller 108 can be configured to control the buzzer 202 to generate a corresponding sound of the at least one sound for the at least one of the one or more events. For example, the controller 108 can be configured to control the buzzer 202 to generate a sound when a severe abnormality has been detected, either alongside or as an alternative to a corresponding light beam (e.g., flashing red). In another example, the sound can be used together with a light beam for alerting different events or a combination of different events. For example, a solid red light without sound can be associated with a minor abnormality due to overcurrent, a solid red light with a first sound can be associated with a minor abnormality due to overvoltage, a solid red light with a second sound can be associated with a minor abnormality due to short circuit. Different sounds can have different sound characteristics. The sound characteristics can include at least one of pitch, volume, duration, tone, rhythm, and/or frequency spectrum. The combination of the buzzer 202 and the light emitting device 110 can provide audible and visual alerts in abnormal situations to enhance user awareness.

In some implementations, with continued reference to FIG. 2, the controller 108 is configured to couple to a computer system 204. The computer system 204 can include a computer-readable medium (e.g., a non-transitory computer-readable medium) storing computer instructions executable by one or more processors. The one or more processors can execute the stored computer instructions to perform operations. The computer system 204 can include a monitor that displays one or more data associated with the operation of the hot plug protection device 200 (e.g., the first signal 120, the second signal 122, the real-time measurement of load property, protection thresholds, and/or abnormalities or events that have been detected). In some examples, settings and configurations (e.g., various thresholds) of the controller 108 can be modified by the users through the laptop interface.

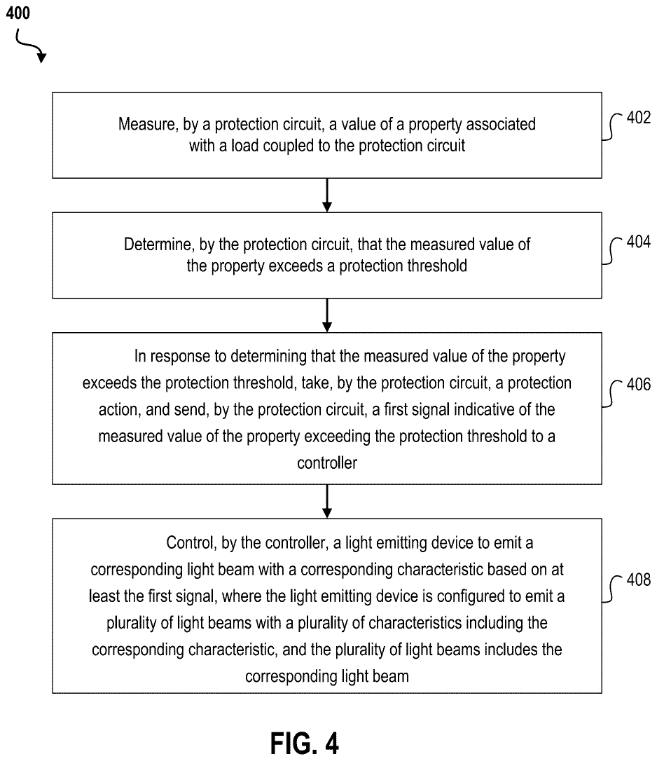

FIG. 4 is a flow chart of an example process 400 of a method for operating a hot plug protection system or device. The hot plug protection system can be, e.g., the hot plug protection system 100 of any one of FIGS. 1 and 2. The hot plug protection device can be, e.g., the hot plug protection device 200 of FIG. 2.

At step 402, a value of a property associated with a load coupled to the protection circuit is measured is by a protection circuit. The protection circuit can be, e.g., the protection circuit 106 of FIGS. 1 and 2. The load can be, e.g., the load 104 of FIGS. 1 and 2.

At step 404, that the measured value of the property exceeds a protection threshold is determined by the protection circuit, as described above in reference to FIGS. 1 and 2.

At step 406, in response to determining that the measured value of the property exceeds the protection threshold, a protection action is taken by the protection circuit, and a first signal indicative of the measured value of the property exceeding the protection threshold is sent by the protection circuit to a controller. The first signal can be, e.g., the first signal 120 of FIG. 1. The controller can be, e.g., the controller 108 of FIGS. 1 and 2.

At step 408, a light emitting device is controlled by the controller to emit a corresponding light beam with a corresponding characteristic based on at least the first signal, where the light emitting device is configured to emit a plurality of light beams with a plurality of characteristics including the corresponding characteristic, and the plurality of light beams includes the corresponding light beam, as described above in reference to FIGS. 1-3. The light emitting device can be, e.g., the light emitting device 110 of FIGS. 1 and 2.

In some implementations, taking the protection action includes limiting an electrical current provided to the load, or cutting off a power provided to the load, as described above in reference to FIGS. 1-3.

In some implementations, the method includes determining a state of the load based on the measured value of the property, the state of the load including at least one of minor abnormality or severe abnormality. Taking the protection action includes one of: in response to a determination of the minor abnormality, limiting the electrical current provided to the load, or in response to a determination of the severe abnormality, cutting off the power provided to the load, as described above in reference to FIGS. 1-3.

In some implementations, determining the state of the load includes determining a deviation of the measured value of the property from the protection threshold, as described above in reference to FIGS. 1-3.

In some implementations, the property associated with the load includes at least one of an electrical current, an electrical voltage, an electrical impedance, or a temperature.

In some implementations, the method includes transmitting, by the protection circuit, a second signal indicative of the measured value of the property to the controller; based on at least one of the first signal or the second signal, determining, by the controller, at least one of one or more events; and for each of the one or more events, controlling, by the controller, the light emitting device to emit a corresponding light beam of the plurality of light beams with a corresponding characteristic of the plurality of characteristics. The second signal can be, e.g., the second signal 122 of FIG. 1.

In some implementations, the one or more events include at least one of: an event where system is ready to receive and/or reject a load; an event where the load has been plugged; an event where the load has been plugged but not been activated; an event where the measured value of the property associated with the load is within the protection threshold; an event where the measured value of the property associated with the load is close to the protection threshold but not does not exceed the protection threshold; an event where a connection between the load and the protection circuit is poor; an event where the measured value of the property associated with the load has exceeded the protection threshold; an event where the protection circuit has been powered off; an event where the protection circuit is in a current limiting mode; or an event where the protection circuit is measuring the property associated with the load, as described above in reference to FIG. 3.

In some implementations, the plurality of characteristics includes at least one of: one or more colors, or one or more flashing frequencies.

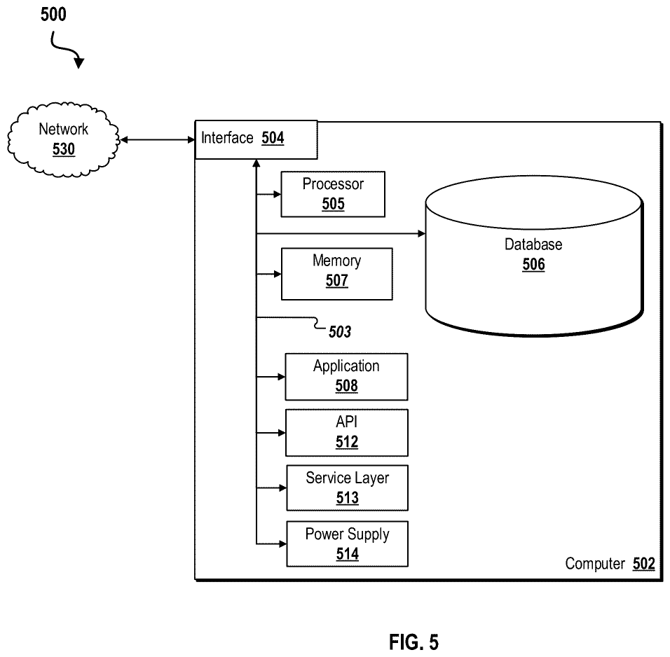

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530. The Computer 502 can be implemented as the host device 102 of FIGS. 1 and 2.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user-or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a system, comprising: a host device configured to receive a load, wherein the host device comprises: a protection circuit configured to be coupled to the load, wherein the protection circuit is configured to: measure a value of a property associated with the load, determine whether the measured value of the property exceeds a protection threshold, and take a protection action in response to determining that the measured value of the property exceeds the protection threshold; a controller coupled to the protection circuit; and a light emitting device coupled to the controller and configured to emit a plurality of light beams with a plurality of characteristics, wherein the protection circuit is further configured to: in response to the measured value of the property exceeding the protection threshold, send a first signal indicative of the measured value of the property exceeding the protection threshold to the controller, and wherein the controller is configured to: receive the first signal and control the light emitting device based on at least the first signal to emit a corresponding light beam of the plurality of light beams with a corresponding characteristic of the plurality of characteristics.

The foregoing and other described implementations can each, optionally, include one or more of the following features:
A first feature, combinable with any of the following features, wherein the protection action comprises: limiting an electrical current provided to the load, or cutting off a power provided to the load.
A second feature, combinable with any of the previous or following features, wherein the protection circuit is configured to: determine a state of the load based on the measured value of the property, the state of the load comprising at least one of minor abnormality or severe abnormality; in response to a determination of the minor abnormality, limit the electrical current provided to the load; and in response to a determination of the severe abnormality, cut off the power provided to the load.
A third feature, combinable with any of the previous or following features, wherein the protection circuit is configured to determine the state of the load by determining a deviation of the measured value of the property from the protection threshold.
A fourth feature, combinable with any of the previous or following features, wherein the protection circuit is further configured to transmit a second signal indicative of the measured value of the property to the controller.
A fifth feature, combinable with any of the previous or following features, wherein the first signal is a digital signal, and the second signal is an analog signal.
A sixth feature, combinable with any of the previous or following features, wherein the controller is configured to: determine a state of the load based on the second signal, the state of the load comprising at least one of minor abnormality or severe abnormality, in response to a determination of the minor abnormality, control the protection circuit to limit an electrical current provided to the load, and in response to a determination of the severe abnormality, control the protection circuit to cut off a power provided to the load.
A seventh feature, combinable with any of the previous or following features, wherein the controller is configured to: based on at least one of the first signal or the second signal, determine at least one of one or more events; and for each of the one or more events, control the light emitting device to emit a corresponding light beam of the plurality of light beams with a corresponding characteristic of the plurality of characteristics.
An eighth feature, combinable with any of the previous or following features, wherein the one or more events comprise at least one of: an event where the host device is ready to receive or reject the load; an event where the load has been plugged; an event where the load has been plugged but not been activated; an event where the measured value of the property associated with the load is within the protection threshold; an event where the measured value of the property associated with the load is close to the protection threshold but does not exceed the protection threshold; an event where a connection between the load and the protection circuit is poor; an event where the measured value of the property associated with the load has exceeded the protection threshold; an event where the protection circuit has been powered off; an event where the protection circuit is in a current limiting mode; or an event where the protection circuit is measuring the property associated with the load.
A ninth feature, combinable with any of the previous or following features, wherein the property comprises at least one of an electrical current or an electrical impedance associated with the load, and wherein the controller is configured to determine that the load has been plugged but not been activated by determining at least one of: a value of the electrical current being smaller than a current threshold, or a value of the electrical impedance being greater than an impedance threshold.
A tenth feature, combinable with any of the previous or following features, wherein the controller is configured to: determine that the connection between the load and the protection circuit is poor based on a result of determining at least one of: a magnitude of fluctuation of the measured value of the property, or a frequency of the fluctuation of the measured value of the property.
An eleventh feature, combinable with any of the previous or following features, further comprising: a buzzer coupled to the controller and configured to generate at least one sound, wherein the controller is configured to control the buzzer to generate a corresponding sound of the at least one sound for the at least one of the one or more events.
A twelfth feature, combinable with any of the previous or following features, wherein the controller is configured to adjust the protection threshold based on the second signal.
A thirteenth feature, combinable with any of the previous or following features, wherein the controller is configured to receive the first signal at a first frequency in a range of 100 Hz to 1000 Hz, and the controller is configured to receive the second signal at a second frequency in a range of 500 Hz to 1500 Hz through I²C (Inter Integrated Circuit) communication.
A fourteenth feature, combinable with any of the previous or following features, wherein the plurality of characteristics comprises at least one of: one or more colors, or one or more flashing frequencies.
A fifteenth feature, combinable with any of the previous or following features, wherein the plurality of characteristics comprises at least one of a flashing blue light, a solid blue light, a flashing green light, a solid green light, a flashing yellow light, a solid yellow light, a flashing red light, or a solid red light.
A sixteenth feature, combinable with any of the previous or following features, wherein the property associated with the load comprises at least one of an electrical current, an electrical voltage, an electrical impedance, or a temperature.
A seventeenth feature, combinable with any of the previous or following features, wherein the protection circuit is further configured to: in response to determining that the measured value of the property exceeds the protection threshold, store the measured value of the property.
An eighteenth feature, combinable with any of the previous or following features, wherein the protection circuit is configured to measure the value of the property associated with the load at a frequency between 1000 Hz to 10,000 Hz.
A nineteenth feature, combinable with any of the previous or following features, wherein the protection circuit is configured to provide power to the load.
A twentieth feature, combinable with any of the previous or following features, further comprising the load that is attachable to and removable from the host device.

In a second implementation, a method, comprising: measuring, by a protection circuit, a value of a property associated with a load coupled to the protection circuit; determining, by the protection circuit, that the measured value of the property exceeds a protection threshold; in response to determining that the measured value of the property exceeds the protection threshold, taking, by the protection circuit, a protection action, and sending, by the protection circuit, a first signal indicative of the measured value of the property exceeding the protection threshold to a controller; and controlling, by the controller, a light emitting device to emit a corresponding light beam with a corresponding characteristic based on at least the first signal, wherein the light emitting device is configured to emit a plurality of light beams with a plurality of characteristics including the corresponding characteristic, and the plurality of light beams comprises the corresponding light beam.

The foregoing and other described implementations can each, optionally, include one or more of the following features:
A first feature, combinable with any of the following features, wherein taking the protection action comprises: limiting an electrical current provided to the load, or cutting off a power provided to the load.
A second feature, combinable with any of the previous or following features, further comprising: determining a state of the load based on the measured value of the property, the state of the load comprising at least one of minor abnormality or severe abnormality, wherein taking the protection action comprises one of: in response to a determination of the minor abnormality, limiting the electrical current provided to the load, or in response to a determination of the severe abnormality, cutting off the power provided to the load.
A third feature, combinable with any of the previous or following features, wherein determining the state of the load comprises determining a deviation of the measured value of the property from the protection threshold.
A fourth feature, combinable with any of the previous or following features, wherein the property associated with the load comprises at least one of an electrical current, an electrical voltage, an electrical impedance, or a temperature.
A fifth feature, combinable with any of the previous or following features, comprising: transmitting, by the protection circuit, a second signal indicative of the measured value of the property to the controller; based on at least one of the first signal or the second signal, determining, by the controller, at least one of one or more events; and for each of the one or more events, controlling, by the controller, the light emitting device to emit a corresponding light beam of the plurality of light beams with a corresponding characteristic of the plurality of characteristics.
A sixth feature, combinable with any of the previous or following features, wherein the one or more events comprise at least one of: an event where the system is ready to receive or reject the load; an event where the load has been plugged; an event where the load has been plugged but not been activated; an event where the measured value of the property associated with the load is within the protection threshold; an event where the measured value of the property associated with the load is close to the protection threshold but not does not exceed the protection threshold; an event where a connection between the load and the protection circuit is poor; an event where the measured value of the property associated with the load has exceeded the protection threshold; an event where the protection circuit has been powered off; an event where the protection circuit is in a current limiting mode; or an event where the protection circuit is measuring the property associated with the load.
A seventh feature, combinable with any of the previous or following features, wherein the plurality of characteristics comprises at least one of: one or more colors, or one or more flashing frequencies.

In a third implementation, a device, comprising: a protection circuit configured to be coupled to a load, wherein the protection circuit is configured to: measure a value of a property associated with the load, determine whether the measured value of the property exceeds a protection threshold, and take a protection action in response to determining that the measured value of the property exceeds the protection threshold; a controller coupled to the protection circuit; and a light emitting device coupled to the controller and configured to emit a plurality of light beams with a plurality of characteristics, wherein the protection circuit is further configured to: in response to the measured value of the property exceeding the protection threshold, send a first signal indicative of the measured value of the property exceeding the protection threshold to the controller; and send a second signal indicative of the measured value of the property to the controller, and wherein the controller is configured to: determine at least one of one or more events based on at least one of the first signal or the second signal; and for each of the one or more events, control the light emitting device to emit a corresponding light beam of the plurality of light beams with a corresponding characteristic of the plurality of characteristics.

The foregoing and other described implementations can each, optionally, include one or more of the following features:
A first feature, combinable with any of the following features, wherein the one or more events comprise at least one of: an event where the system is ready to receive or reject the load; an event where the load has been plugged; an event where the load has been plugged but not been activated; an event where the measured value of the property associated with the load is within the protection threshold; an event where the measured value of the property associated with the load is close to the protection threshold but not does not exceed the protection threshold; an event where a connection between the load and the protection circuit is poor; an event where the measured value of the property associated with the load has exceeded the protection threshold; an event where the protection circuit has been powered off; an event where the protection circuit is in a current limiting mode; or an event where the protection circuit is measuring the property associated with the load.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

The term “and/or” can refer to and encompasses any and all possible combinations of one or more of the associated listed terms. For example, the term “A and/or B” means that either option A, option B, or both options A and B are possible, where A and B may be singular or plural.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the corresponding computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A system, comprising:
a host device configured to receive a load, wherein the host device comprises:
a protection circuit configured to be coupled to the load, wherein the protection circuit is configured to:
measure a value of a property associated with the load,
determine whether the measured value of the property exceeds a protection threshold, and
take a protection action in response to determining that the measured value of the property exceeds the protection threshold;
a controller coupled to the protection circuit; and
a light emitting device coupled to the controller and configured to emit a plurality of light beams with a plurality of characteristics,
wherein the protection circuit is further configured to:
in response to the measured value of the property exceeding the
protection threshold, send a first signal indicative of the measured value of the property exceeding the protection threshold to the controller, and
wherein the controller is configured to:
receive the first signal and control the light emitting device based on at least the first signal to emit a corresponding light beam of the plurality of light beams with a corresponding characteristic of the plurality of characteristics.

2. The system of claim 1, wherein the protection action comprises:
limiting an electrical current provided to the load, or
cutting off a power provided to the load.

3. The system of claim 2, wherein the protection circuit is configured to:
determine a state of the load based on the measured value of the property, the state of the load comprising at least one of minor abnormality or severe abnormality;
in response to a determination of the minor abnormality, limit the electrical current provided to the load; and
in response to a determination of the severe abnormality, cut off the power provided to the load.

4. The system of claim 1, wherein the protection circuit is further configured to transmit a second signal indicative of the measured value of the property to the controller.

5. The system of claim 4, wherein the controller is configured to:
determine a state of the load based on the second signal, the state of the load comprising at least one of minor abnormality or severe abnormality,
in response to a determination of the minor abnormality, control the protection circuit to limit an electrical current provided to the load, and
in response to a determination of the severe abnormality, control the protection circuit to cut off a power provided to the load.

6. The system of claim 4, wherein the controller is configured to:
based on at least one of the first signal or the second signal,
determine at least one of one or more events; and
for each of the one or more events, control the light emitting device to emit a
corresponding light beam of the plurality of light beams with a corresponding characteristic of the plurality of characteristics.

7. The system of claim 6, wherein the one or more events comprise at least one of:
an event where the host device is ready to receive or reject the load;
an event where the load has been plugged;
an event where the load has been plugged but not been activated;
an event where the measured value of the property associated with the load is within the protection threshold;
an event where the measured value of the property associated with the load is close to the protection threshold but does not exceed the protection threshold;
an event where a connection between the load and the protection circuit is poor;
an event where the measured value of the property associated with the load has exceeded the protection threshold;
an event where the protection circuit has been powered off;
an event where the protection circuit is in a current limiting mode; or
an event where the protection circuit is measuring the property associated with the load.

8. The system of claim 7, wherein the property comprises at least one of an electrical current or an electrical impedance associated with the load, and
wherein the controller is configured to determine that the load has been plugged but not been activated by determining at least one of:
a value of the electrical current being smaller than a current threshold, or
a value of the electrical impedance being greater than an impedance threshold.

9. The system of claim 7, wherein the controller is configured to:
determine that the connection between the load and the protection circuit is poor based on a result of determining at least one of:
a magnitude of fluctuation of the measured value of the property, or
a frequency of the fluctuation of the measured value of the property.

10. The system of claim 4, wherein the controller is configured to adjust the protection threshold based on the second signal.

11. The system of claim 1, wherein the plurality of characteristics comprises at least one of:
one or more colors, or
one or more flashing frequencies.

12. The system of claim 1, wherein the property associated with the load comprises at least one of an electrical current, an electrical voltage, an electrical impedance, or a temperature.

13. A method, comprising:
measuring, by a protection circuit, a value of a property associated with a load coupled to the protection circuit;
determining, by the protection circuit, that the measured value of the property exceeds a protection threshold;
in response to determining that the measured value of the property exceeds the protection threshold,
taking, by the protection circuit, a protection action, and
sending, by the protection circuit, a first signal indicative of the measured value of the property exceeding the protection threshold to a controller; and
controlling, by the controller, a light emitting device to emit a corresponding light beam with a corresponding characteristic based on at least the first signal, wherein the light emitting device is configured to emit a plurality of light beams with a plurality of characteristics including the corresponding characteristic, and the plurality of light beams comprises the corresponding light beam.

14. The method of claim 13, wherein taking the protection action comprises:
limiting an electrical current provided to the load, or
cutting off a power provided to the load.

15. The method of claim 14, further comprising:
determining a state of the load based on the measured value of the property, the state of the load comprising at least one of minor abnormality or severe abnormality,
wherein taking the protection action comprises one of:
in response to a determination of the minor abnormality, limiting the electrical current provided to the load, or
in response to a determination of the severe abnormality, cutting off the power provided to the load.

16. The method of claim 13, comprising:
transmitting, by the protection circuit, a second signal indicative of the measured value of the property to the controller;
based on at least one of the first signal or the second signal, determining, by the controller, at least one of one or more events; and
for each of the one or more events, controlling, by the controller, the light emitting device to emit a corresponding light beam of the plurality of light beams with a corresponding characteristic of the plurality of characteristics.

17. The method of claim 16, wherein the one or more events comprise at least one of:
an event where a host device is ready to receive or reject the load;
an event where the load has been plugged;
an event where the load has been plugged but not been activated;
an event where the measured value of the property associated with the load is within the protection threshold;
an event where the measured value of the property associated with the load is close to the protection threshold but not does not exceed the protection threshold;
an event where a connection between the load and the protection circuit is poor;
an event where the measured value of the property associated with the load has exceeded the protection threshold;
an event where the protection circuit has been powered off;
an event where the protection circuit is in a current limiting mode; or
an event where the protection circuit is measuring the property associated with the load.

18. The method of claim 17, wherein the plurality of characteristics comprises at least one of:
one or more colors, or
one or more flashing frequencies.

19. A device, comprising:
a protection circuit configured to be coupled to a load, wherein the protection circuit is configured to:
measure a value of a property associated with the load,
determine whether the measured value of the property exceeds a protection threshold, and
take a protection action in response to determining that the measured value of the
property exceeds the protection threshold;
a controller coupled to the protection circuit; and
a light emitting device coupled to the controller and configured to emit a plurality of light beams with a plurality of characteristics,
wherein the protection circuit is further configured to:
in response to the measured value of the property exceeding the protection
threshold, send a first signal indicative of the measured value of the property exceeding the protection threshold to the controller; and
send a second signal indicative of the measured value of the property to the controller, and
wherein the controller is configured to:
determine at least one of one or more events based on at least one of the first signal or the second signal; and
for each of the one or more events, control the light emitting device to emit a
corresponding light beam of the plurality of light beams with a corresponding characteristic of the plurality of characteristics.

20. The device of claim 19, wherein the one or more events comprises at least one of:
an event where a host device is ready to receive or reject the load;
an event where the load has been plugged;
an event where the load has been plugged but not been activated;
an event where the measured value of the property associated with the load is within the protection threshold;
an event where the measured value of the property associated with the load is close to the protection threshold but does not exceed the protection threshold;
an event where a connection between the load and the protection circuit is poor;
an event where the measured value of the property associated with the load has exceeded the protection threshold;
an event where the protection circuit has been powered off;
an event where the protection circuit is in a current limiting mode; or
an event where the protection circuit is measuring the property associated with the load.
